(19) United States
(12) Patent Application Publication
(10) Pub. No.: US 2014/0229940 A1
(43) Pub. Date: Aug. 14, 2014

(54) METHODS AND APPARATUS FOR SYNCHRONIZING MULTIPLE PROCESSORS OF A VIRTUAL MACHINE

(71) Applicant: General Dynamics C4 Systems, Inc., Scottsdale, AZ (US)

(72) Inventor: Carl Frans van Schaik, Kingsford (AU)

(73) Assignee: General Dynamics C4 Systems, Inc., Scottsdale, AZ (US)

(21) Appl. No.: 13/767,191

(22) Filed: Feb. 14, 2013

(51) Int. Cl. G06F 9/455

(52) U.S. Cl. CPC G06F 9/45533
USPC 718/1

(57) ABSTRACT

Methods and apparatus for synchronizing multiple virtual processors of a virtual machine are disclosed. A hypervisor schedules a first virtual processor in a virtual machine to execute using a first physical processor. Subsequently, the hypervisor receives an indication from the first virtual processor that it is waiting on a second different virtual processor. If the second virtual processor is not already running on another physical processor, the hypervisor saves the priority associated with the first virtual processor, lowers the priority associated with the first virtual processor, and schedules the second virtual processor to execute using the first physical processor or another physical processor.

The present disclosure relates in general to virtual machines, and, in particular, to methods and apparatus for synchronizing multiple processors of a virtual machine.

### BACKGROUND OF THE INVENTION

A hypervisor is a software interface between the physical hardware of a computing device, such as a wireless telephone or vehicle user interface system, and multiple operating systems. Each operating system managed by the hypervisor is associated with a different virtual machine, and each operating system appears to have exclusive access to the underlying hardware, such as processors, user interface devices, and memory. However, the hardware is a shared resource, and the hypervisor controls all hardware access (e.g., via prioritized time sharing). In order to give each virtual machine the appearance of exclusive access to one or more physical processors, the hypervisor schedules one or more virtual processors on one or more physical processors. However, two or more virtual processors may require synchronization.

A common method of synchronization in multi-core OS kernels is memory based synchronization. Spinlocks are a classical example. A spinlock uses a shared lock variable that is atomically test-and-set or cleared. The spinlock can be locked by the kernel on one processor at a time, and other kernels on other processors have to wait for the spinlock to be released before claiming the lock. The waiting software repeatedly loops testing the lock variable and attempting to claim it once it is unlocked.

In a virtualized environment, spinlocks may cause a problem if a virtual machine's virtual processors are not scheduled concurrently, and/or if a virtual machine contains more virtual processors than available physical processors. If a virtual processor that is holding the spinlock is no longer scheduled by the hypervisor for execution on a physical processor, other virtual processors attempting to acquire the spinlock, which do not have access to the hypervisor's scheduling information, may attempt to acquire the spinlock. Since the virtual processor holding the spinlock is not scheduled for execution on a physical processor, it will not release the lock, and the waiting virtual processor(s) will use up and waste available processor time.

### BRIEF DESCRIPTION OF THE DRAWINGS

FIG. 1 is a block diagram of an example network communication system.

FIG. 2 is a block diagram of an example electronic device.

FIG. 3 is a block diagram of another example electronic device.

FIG. 4 is a block diagram of yet another example electronic device.

FIG. 5 is a flowchart of an example process for synchronizing multiple processors of a virtual machine.

### DETAILED DESCRIPTION OF THE PREFERRED EMBODIMENTS

Briefly, methods and apparatus for synchronizing multiple virtual processors of a virtual machine are disclosed. In an embodiment, a hypervisor schedules a first virtual processor in a virtual machine to execute using a first physical processor. Subsequently, the hypervisor receives an indication from the first virtual processor that it is waiting on a second different virtual processor. If the second virtual processor is not already running on another physical processor, the hypervisor saves the priority associated with the first virtual processor, lowers the priority associated with the first virtual processor, and schedules the second virtual processor to execute using the first physical processor or another physical processor.

Among other features, the methods and apparatus disclosed herein facilitate an efficient virtualization of multi-core guest operating systems that use memory based synchronization techniques. Processor cycles are not wasted by virtual processors waiting for a synchronization event (such as unlocking a spinlock), and the hypervisor can schedule other system virtual processors while the spinning virtual processor is waiting. The disclosed system supports reduced latency by scheduling the lock holder (if known and not scheduled on another physical processor), and also maintains low latency in the case where the lock holder is running on another physical processor by allowing the waiting processor to continue polling for the event (e.g. unlock of spinlock). The system also supports reduced latency in the case that the lock holder releases the lock, giving an indication to the hypervisor, which allows the waiting virtual processor to be scheduled. For example, the hypervisor may restore the priority of the waiting virtual processor to a saved priority, and the waiting virtual processor may be preferentially selected to execute sooner or next.

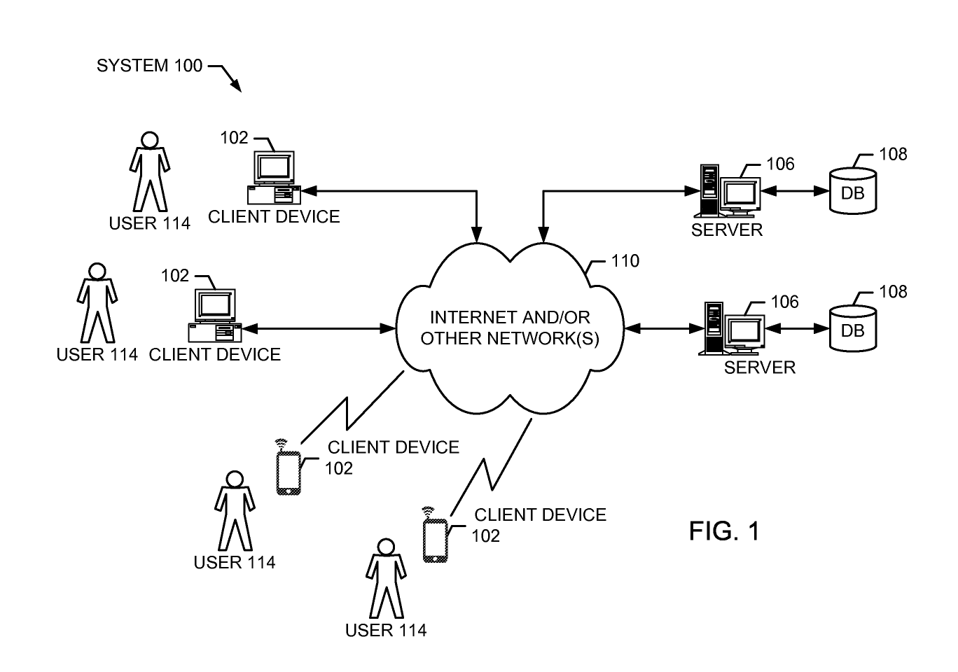

The present system may be used in a network communications system. A block diagram of certain elements of an example network communications system 100 is illustrated in FIG. 1. The illustrated system 100 includes one or more client devices 102 (e.g., computer, television, camera, phone), one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, fewer low power microprocessors, and a single network connection.

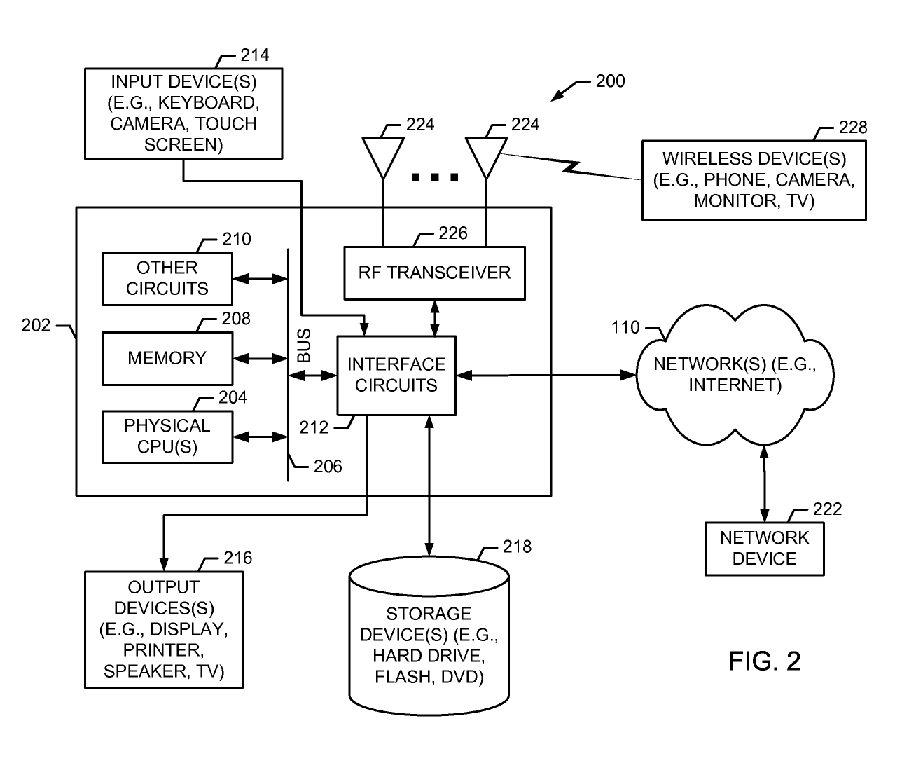

Each of the devices illustrated in FIG. 1 may include certain common aspects of many electronic devices such as microprocessors, memories, peripherals, etc. A block diagram of certain elements of an example electronic device 200 that may be used to capture, store, and/or playback digital video is illustrated in FIG. 2. For example, the electrical device 200 may be a client, a server, a camera, a phone, and/or a television.

The example electrical device 200 includes a main unit 202 which may include, if desired, one or more physical processors 204 electrically coupled by an address/data bus 206 to one or more memories 208, other computer circuitry 210, and one or more interface circuits 212. The processor 204 may be any suitable processor or plurality of processors. For example, the electrical device 200 may include a central processing unit (CPU) and/or a graphics processing unit (GPU). The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processor 204 in any suitable manner. The memory 208 may also store digital data indicative of documents, files, programs, web pages, etc. retrieved from a server and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, isopoint, camera and/or a voice recognition system.

One or more displays, printers, speakers, monitors, televisions, high definition televisions, and/or other suitable output devices 216 may also be connected to the main unit 202 via the interface circuit 212. The display 216 may be a cathode ray tube (CRTs), liquid crystal displays (LCDs), or any other type of suitable display. The display 216 generates visual displays of data generated during operation of the device 200. For example, the display 216 may be used to display web pages and/or other content received from a server. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 200.

The electrical device 200 may also exchange data with other network devices 222 via a connection to a network. The network connection may be any type of network connection, such as an Ethernet connection, digital subscriber line (DSL), telephone line, coaxial cable, etc. Users of the system may be required to register with a server. In such an instance, each user may choose a user identifier (e.g., e-mail address) and a password which may be required for the activation of services. The user identifier and password may be passed across the network using encryption built into the user's browser. Alternatively, the user identifier and/or password may be assigned by the server.

In some embodiments, the device 200 may be a wireless device. In such an instance, the device 200 may include one or more antennas 224 connected to one or more radio frequency (RF) transceivers 226. The transceiver 226 may include one or more receivers and one or more transmitters. For example, the transceiver 226 may be a cellular transceiver. The transceiver 226 allows the device 200 to exchange signals, such as voice, video and data, with other wireless devices 228, such as a phone, camera, monitor, television, and/or high definition television. For example, the device may send and receive wireless telephone signals, text messages, audio signals and/or video signals.

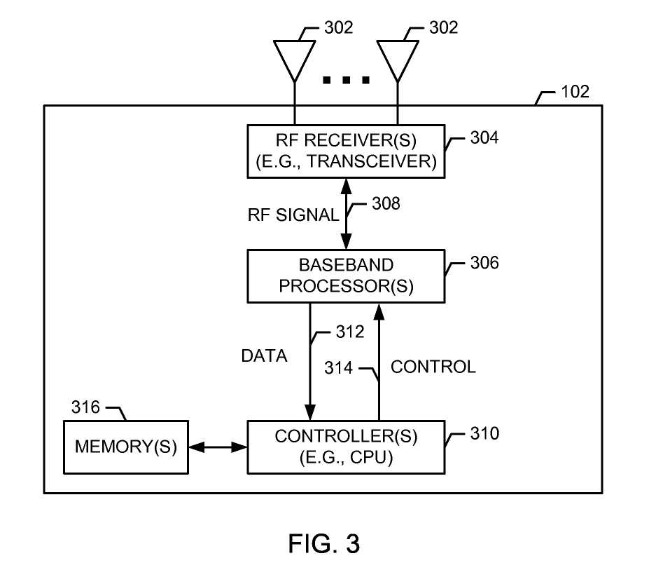

A block diagram of certain elements of an example wireless device 102 for sharing memory between multiple processes of a virtual machine is illustrated in FIG. 3. The wireless device 102 may be implemented in hardware or a combination of hardware and hardware executing software. In one embodiment, the wireless device 102 may include a CPU executing software. Other suitable hardware may include one or more application specific integrated circuits (ASICs), state machines, field programmable gate arrays (FPGAs), and/or digital signal processors (DSPs).

In this example, the wireless device 102 includes a plurality of antennas 302 operatively coupled to one or more radio frequency (RF) receivers 304. The receiver 304 is also operatively coupled to one or more baseband processors 306. The receiver 304 tunes to one or more radio frequencies to receive one or more radio signals 308, which are passed to the baseband processor 306 in a well known manner. The baseband processor 306 is operatively coupled to one or more controllers 310. The baseband processor 306 passes data 312 to the controller 310. A memory 316 operatively coupled to the controller 310 may store the data 312.

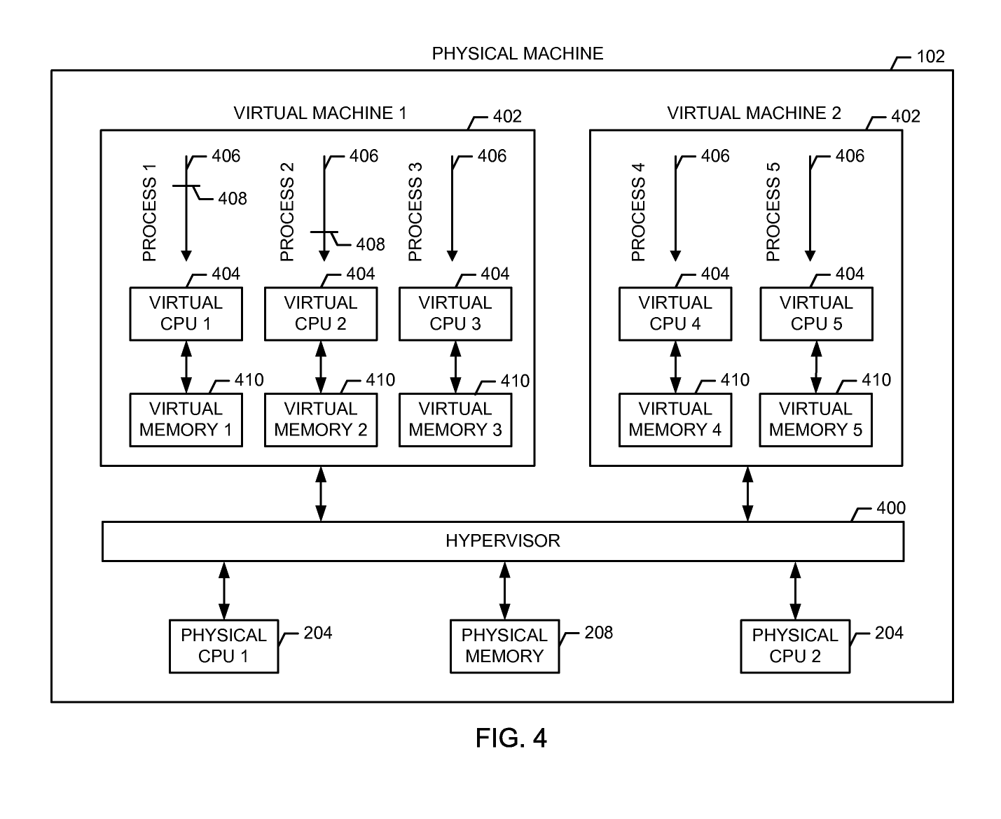

A block diagram of certain elements of yet another example electronic device is illustrated in FIG. 4. In this example, a physical machine 102 includes two physical processors 204. However, any suitable number of physical processors 204 may be included in the physical machine 102. For example, the physical machine 102 may include a multi-core central processing unit with four or more cores. The physical machine 102 also includes one or more physical memories 208 for use by the physical processors 204. For example, the physical machine 102 may include dynamic random access memory (DRAM).

A plurality of virtual machines 402 execute within the physical machine 102. Each virtual machine 402 is a software implementation of a computer and the operating system associated with that computer. Different virtual machines 402 within the same physical machine 102 may use different operating systems. For example, a mobile communication device may include three virtual machines 402 where two of the virtual machines 402 are executing the Android operating system and one of the virtual machines 402 is executing a different Linux operating system.

Each virtual machine 402 includes one or more virtual processors 404 and associated virtual memory 410. Each virtual processor 404 executes one or more processes 406 using one or more of the physical processors 204. Similarly, the contents of each virtual memory 410 are stored in the physical memory 208.

A hypervisor 400 controls access by the virtual machines 402 to the physical processors 204 and the physical memory 208. More specifically, the hypervisor 400 schedules each virtual processor 404, which executes one or more processes 406, on an available physical processor 204 according to the relative priorities associated with the virtual machines 402. Once the hypervisor 400 schedules a virtual processor 204 to execute on a physical processor 204, the virtual processor 204 typically advances to a progress point 408 unless suspended by the hypervisor 400.

The hypervisor 400 also allocates physical memory 208 to each of the virtual machines 402. In some instances, the hypervisor 400 protects one portion of physical memory 208 associated with one process 406 from another portion of physical memory 208 associated with another process 406. In other instances, the hypervisor 400 allows one portion of physical memory 208 associated with one process 406 to be accessed by another process 406 associated with another virtual machine 402. In this manner, the hypervisor 400 facilitates the sharing of memory between multiple processes 406 of a virtual machine 402.

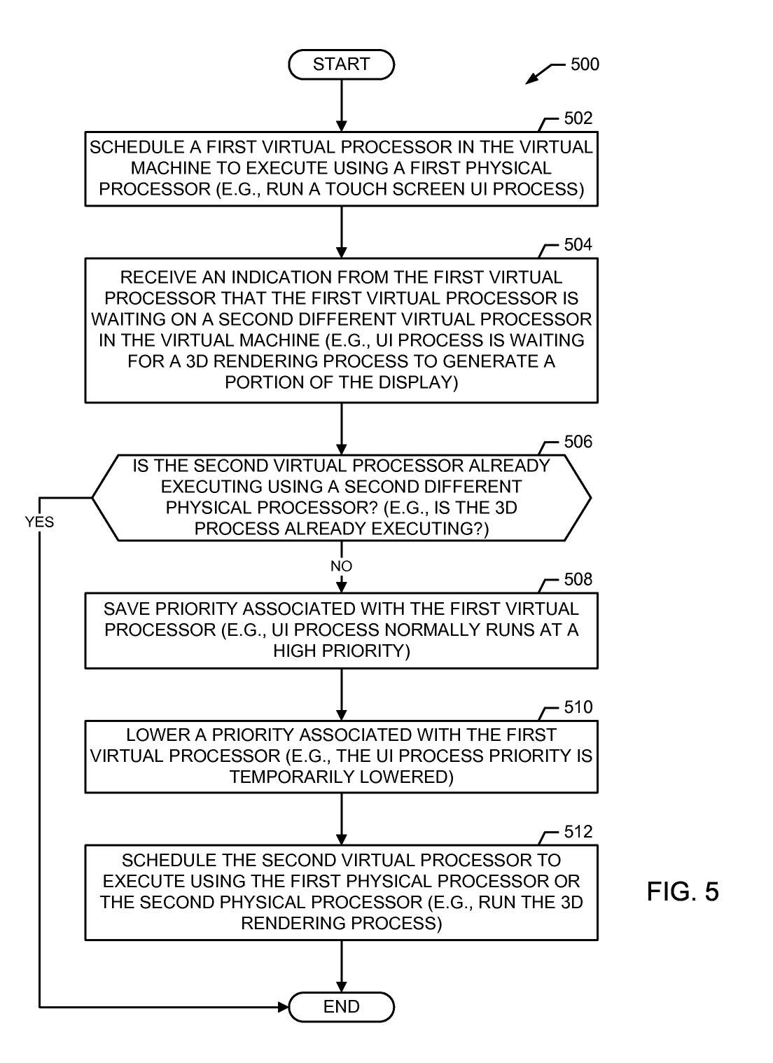

A flowchart of an example process 500 for synchronizing multiple processors of a virtual machine is illustrated in FIG. 5. The process 500 may be carried out by one or more suitably programmed processors such as a CPU executing software (e.g., block 204 of FIG. 2). The process 500 may also be embodied in hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 500 is described with reference to the flowchart illustrated in FIG. 5, it will be appreciated that many other methods of performing the acts associated with process 500 may be used. For example, the order of many of the operations may be changed, and some of the operations described may be optional.

In general, a hypervisor 400 schedules a first virtual processor 404 in a virtual machine 402 to execute using a first physical processor 204. Subsequently, the hypervisor 400 receives an indication from the first virtual processor 404 that it is waiting on a second different virtual processor 404. If the second virtual processor 404 is not already running on another physical processor, the hypervisor 400 saves the priority associated with the first virtual processor 404, lowers the priority associated with the first virtual processor 404, and schedules the second virtual processor 404 to execute using the first physical processor 204 and/or another physical processor 204.

More specifically, the example process 500 begins when the hypervisor 400 schedules a first virtual processor 404 in a virtual machine 402 to execute using a first physical processor 204 (block 502). For example, the hypervisor 400 may schedule a virtual processor 404 running a touch screen user interface process to execute on a certain physical processor 204. The hypervisor 400 then receives an indication from the first virtual processor 404 that the first virtual processor 404 is waiting on a second different virtual processor 404 in the same virtual machine 402 (block 504). For example, the hypervisor 400 may receives an indication from the user interface process that the user interface process is waiting for a 3D rendering process to generate a portion of the user interface display.

The hypervisor 400 then determines if the second virtual processor 404 is already executing using a second different physical processor 204 (block 506). For example, the hypervisor 400 may determine if the 3D rendering process is already running. The hypervisor 400 then saves the priority associated with the first virtual processor 404 (block 508). For example, the user interface process may be running at a high priority, and the hypervisor 400 may store the level of that priority in memory 208 so that the user interface process may be restored to this higher priority later.

The hypervisor 400 then lowers the priority associated with the first virtual processor 404 (block 510). For example, the hypervisor 400 may lower the priority of the user interface process that is waiting on the 3D rendering process. The hypervisor 400 then schedules the second virtual processor 404 to execute using the first physical processor 204 or the second physical processor 204 (block 512). For example, the hypervisor 400 may schedule the 3D rendering process to run on the first physical processor 204 now that the user interface process is temporarily running at a lower priority.

In summary, persons of ordinary skill in the art will readily appreciate that methods and apparatus for synchronizing multiple virtual processors of a virtual machine have been provided. Among other features, the methods and apparatus disclosed herein facilitate an efficient virtualization of multi-core guest operating systems that use memory based synchronization techniques. Processor cycles are not wasted by virtual processors waiting for a synchronization event (such as unlocking a spinlock), and the hypervisor can schedule other system virtual processors while the spinning virtual processor is waiting. The disclosed system supports reduced latency by scheduling the lock holder (if known and not scheduled on another physical processor), and also maintains low latency in the case where the lock holder is running on another physical processor by allowing the waiting processor to continue polling for the event (e.g. unlock of spinlock).

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of synchronizing multiple virtual processors of a virtual machine, the method comprising:
scheduling a first virtual processor in the virtual machine to execute using a first physical processor;
receiving an indication from the first virtual processor that the first virtual processor is waiting on a second different virtual processor in the virtual machine;
determining if the second virtual processor is already executing using a second different physical processor;
lowering a priority associated with the first virtual processor if the second virtual processor is not already executing using the second different physical processor; and
scheduling the second virtual processor to execute using at least one of the first physical processor, the second physical processor, and a third physical processor.

2. The method of claim 1, wherein the priority associated with the first virtual processor remains the same if the second virtual processor is already executing using the second physical processor.

3. The method of claim 1, wherein the first virtual processor and second virtual processor are both scheduled to execute if the second virtual processor is already executing using the second physical processor.

4. The method of claim 1, wherein receiving the indication from the first virtual processor that the first virtual processor is waiting on the second virtual processor includes receiving an identifier indicative of the second virtual processor.

5. The method of claim 1, further comprising saving a current priority associated with the first virtual processor before lowering the priority associated with the first virtual processor, and subsequently raising the priority associated with the first virtual processor back to the saved priority in response to receiving an indication from the second virtual processor.

6. The method of claim 5, wherein the indication from the second virtual processor includes at least one of (1) an indication that the second virtual processor has completed an operation and (2) an indication that the second virtual processor has released a resource such that the first virtual processor is longer waiting on the second virtual processor.

7. The method of claim 1, wherein the first virtual processor is associated with a base priority.

8. The method of claim 7, further comprising receiving an interrupt associated with the first virtual processor and raising the priority associated with the first virtual processor to the base priority in response to receiving the interrupt.

9. The method of claim 1, wherein lowering the priority associated with the first virtual processor includes lowering the priority associated with the first virtual processor to a lowest priority.

10. The method of claim 1, wherein scheduling the first virtual processor and the second virtual processor is performed by a hypervisor.

11. An apparatus for synchronizing multiple virtual processors of a virtual machine, the apparatus comprising:
a hypervisor; and
a first physical processor operatively coupled to the hypervisor, wherein the hypervisor is structured to:
schedule a first virtual processor in the virtual machine to execute using the first physical processor;
receive an indication from the first virtual processor that the first virtual processor is waiting on a second different virtual processor in the virtual machine;
determine if the second virtual processor is already executing using a second different physical processor;
lower a priority associated with the first virtual processor if the second virtual processor is not already executing using the second different physical processor; and
schedule the second virtual processor to execute using at least one of the first physical processor, the second physical processor, and a third physical processor.

12. The apparatus of claim 11, further comprising the second physical processor, wherein the second physical processor is operatively coupled to the hypervisor.

13. The apparatus of claim 11, wherein the hypervisor comprises software executing at least in part on the first physical processor.

14. The apparatus of claim 11, wherein the hypervisor is structured to maintain the priority associated with the first virtual processor if the second virtual processor is already executing using the second physical processor.

15. The apparatus of claim 11, wherein the first virtual processor and second virtual processor are both scheduled to execute if the second virtual processor is already executing using the second physical processor.

16. The apparatus of claim 11, wherein the hypervisor is structured to receive the indication from the first virtual processor that the first virtual processor is waiting on the second virtual processor includes being structured to receive an identifier indicative of the second virtual processor.

17. The apparatus of claim 11, wherein the hypervisor is structured to save a current priority associated with the first virtual processor before lowering the priority associated with the first virtual processor, and subsequently raise the priority associated with the first virtual processor back to the saved priority in response to receiving an indication from the second virtual processor.

18. The apparatus of claim 17, wherein the indication from the second virtual processor includes at least one of (1) an indication that the second virtual processor has completed an operation and (2) an indication that the second virtual processor has released a resource such that the first virtual processor is longer waiting on the second virtual processor.

19. The apparatus of claim 11, wherein the first virtual processor is associated with a base priority.

20. The method of claim 19, wherein the hypervisor is structured to receive an interrupt associated with the first virtual processor and raise the priority associated with the first virtual processor to the base priority in response to receiving the interrupt.

21. The apparatus of claim 11, wherein the hypervisor being structured to lower the priority associated with the first virtual processor includes being structured to lower the priority associated with the first virtual processor to a lowest priority.

22. A computer readable memory storing instructions structured to cause an electronic device to:
schedule a first virtual processor in the virtual machine to execute using a first physical processor;
receive an indication from the first virtual processor that the first virtual processor is waiting on a second different virtual processor in the virtual machine;
determine if the second virtual processor is already executing using a second different physical processor;
lower a priority associated with the first virtual processor if the second virtual processor is not already executing using the second different physical processor; and
schedule the second virtual processor to execute using at least one of the first physical processor, the second physical processor, and a third physical processor.

23. The computer readable memory of claim 22, wherein the instructions are structured to cause the electronic device to maintain the priority associated with the first virtual processor if the second virtual processor is already executing using the second physical processor.

24. The computer readable memory of claim 22, wherein the instructions are structured to cause the electronic device to schedule the first virtual processor and second virtual processor to execute if the second virtual processor is already executing using the second physical processor.

25. The computer readable memory of claim 22, wherein the instructions being structured to receive the indication from the first virtual processor that the first virtual processor is waiting on the second virtual processor includes being structured to receive an identifier indicative of the second virtual processor.

26. The computer readable memory of claim 22, wherein the instructions are structured to cause the electronic device to save a current priority associated with the first virtual processor before lowering the priority associated with the first virtual processor, and subsequently raise the priority associated with the first virtual processor back to the saved priority in response to receiving an indication from the second virtual processor.

27. The method of claim 26, wherein the indication from the second virtual processor includes at least one of (1) an indication that the second virtual processor has completed an operation and (2) an indication that the second virtual processor has released a resource such that the first virtual processor is longer waiting on the second virtual processor.

28. The computer readable memory of claim 22, wherein the first virtual processor is associated with a base priority.

29. The computer readable memory of claim 28, wherein the instructions are structured cause the electronic device to receive an interrupt associated with the first virtual processor and raise the priority associated with the first virtual processor to the base priority in response to receiving the interrupt.

30. The computer readable memory of claim 22, wherein the instructions being structured to cause the electronic device to lower the priority associated with the first virtual processor includes being structured to lower the priority associated with the first virtual processor to a lowest priority.

31. A method of synchronizing multiple virtual processors of a virtual machine, the method comprising:
scheduling a first virtual processor in the virtual machine to execute using at least one physical processor;
receiving an indication from the first virtual processor that the first virtual processor is waiting for a resource from a second virtual processor;
saving a priority level of the first virtual processor;
lowering the priority level of the first virtual processor; and
scheduling the second virtual processor to execute using the at least one physical processor.

32. The method of claim 31, further comprising:
receiving an indication from the second virtual processor that the second virtual processor has released the resource; and
restoring the priority level of the first virtual processor to the saved priority level.

33. The method of claim 31, wherein the priority level of the first virtual processor remains the same if the second virtual processor is already executing.

34. The method of claim 31, wherein receiving the indication from the first virtual processor that the first virtual processor is waiting for a resource held by the second virtual processor includes receiving an identifier indicative of the second virtual processor.

35. The method of claim 31, further comprising:
receiving an interrupt associated with the first virtual processor; and
raising the priority level associated with the first virtual processor to a base priority in response to receiving the interrupt associated with the first virtual processor.

36. The method of claim 31, wherein lowering the priority level associated with the first virtual processor includes lowering the priority level associated with the first virtual processor to a lowest priority.

37. The method of claim 31, wherein scheduling the first virtual processor and the second virtual processor is performed by a hypervisor.

38. The method of claim 31, further comprising:
receiving an indication from a third virtual processor that the third virtual processor is waiting for the resource from the second virtual processor;
saving a priority level of the third virtual processor; and
lowering the priority level of the third virtual processor.

39. The method of claim 38, further comprising:
receiving an indication from the second virtual processor that the second virtual processor has released the resource; and
restoring the priority level of the third virtual processor to the saved priority level.

40. The method of claim 38, further comprising:
receiving an interrupt associated with the third virtual processor; and
raising the priority level associated with the third virtual processor in response to receiving the interrupt associated with the third virtual processor.
